(19) United States
(12) Patent Application Publication
(10) Pub. No.: US 2026/0237172 A1
(43) Pub. Date: Aug. 13, 2026

(54) TAGGING OF THREE-DIMENSIONAL POINT CLOUD DATA

(71) Applicant: Palantir Technologies Inc., Denver, CO (US)

(72) Inventors: Benjamin Rucker, Palo Alto, CA (US); Henry Warhurst, Stockholm (SE); Rick Surya, London (GB); Claudia Chu, Brooklyn, NY (US); Xiaoning He, London (GB); Joshua Bird, Cambridge (GB); David Han, Vienna, VA (US); Arnav Chandra, Clifton, VA (US); Annie Li, Palo Alto, CA (US); Daphne Li-Chen, Palo Alto, CA (US); Manu Gupta, Westbury, NY (US); Emilio Rogalla, Arlington, VA (US); Achintya Singh, Bothell, WA (US); Cyuzuzo Hervé Ishimwe, Princeton, NJ (US); Joseph Jang, Jersey City, NJ (US); Wade Cappa, Lake Tapps, WA (US); Nihal Bhatnagar, Jersey City, NJ (US); Abhinav Chadaga, Flower Mound, TX (US)

(21) Appl. No.: 19/189,881

(22) Filed: Apr. 25, 2025

Related U.S. Application Data
(60) Provisional application No. 63/757,588, filed on Feb. 12, 2025.

(51) Int. Cl. G06T 19/20

(52) U.S. Cl. CPC G06T 19/20; G06T 2219/2004; G06T 2219/2016

(57) ABSTRACT

A computing system accesses a point cloud scan and a user interface is provided that displays the point cloud scan. A selection is received of a first object in the point cloud scan, and a selection is received of a three-dimensional tag container. The three-dimensional tag container is placed at the selected first object in the point cloud scan displayed by the user interface. A search is performed for an association of the selected first object with one or more data objects and an association of the selected first object with at least a first data object is identified. A link graph graphically is rendered depicting the association of selected first object with the first data object.

### CROSS-REFERENCE TO RELATED APPLICATIONS

This application claims benefit of U.S. Provisional Patent Application No. 63/757588, filed February 12, 2025, and titled “TAGGING OF THREE-DIMENSIONAL POINT CLOUD DATA.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for data integration, image processing, and visualization, and to linking objects in images to data in other mediums.

### BACKGROUND

A data system may receive multiple types of data, which may comprise data in different forms. A data ingestion system, which may be at least partially automated, may attempt to identify characteristics of data items that are stored in a data management system. Data items may then be viewed by a user, such as to allow the user to identify portions of the data for further review, either by the user and/or other users. Thus, providing the data items in a way that maximizes the user’s ability to identify relevant portions of data items, regardless of the form of the data items that are originally processed by the data ingestion system, can increase efficiency of such a data management system.

### SUMMARY

A LiDAR (Light Detection and Ranging) sensor may be utilized to generate point cloud models of objects and environments. With LiDAR, laser light is emitted from a transmitter and reflected from objects in a scene. The reflected light is detected by the LiDAR receiver and the time of flight (TOF) is used to develop a distance map of the objects in the scene. LiDAR sensors have become more accessible, and can be found on phones, tablets, and stand-alone cameras. With the increasing availability of LiDAR the generation and use of point cloud models has become more feasible.

Disadvantageously, conventionally it has not been practical to incorporate point cloud models of objects and scenes into systems that are configured to enable tagging of objects in text and two-dimensional images, and that are configured to identify links between objects in text and two-dimensional images. Thus, the potential of utilizing the vast amount of data provided by point cloud models has not been adequately realized.

In various embodiments, large amounts of data are automatically and dynamically calculated interactively in response to user inputs, and the calculated data is efficiently and compactly presented to a user by the system. Thus, in some embodiments, the user interfaces described herein are more efficient as compared to previous user interfaces in which data is not dynamically updated and compactly and efficiently presented to the user in response to interactive inputs.

Further, as described herein, the system may be configured and/or designed to generate user interface data usable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces “that are useable and easily learned by humans is a non-trivial problem for software developers.” (Dillon, A. (2003) User Interface Design. MacMillan Encyclopedia of Cognitive Science, Vol. 4, London: MacMillan, 453-458.) The various embodiments of interactive and dynamic user interfaces of the present disclosure are the result of significant research, development, improvement, iteration, and testing. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interfaces described herein may provide an optimized display of time-varying report-related information and may enable a user to more quickly access, navigate, assess, and digest such information than previous systems.

In some embodiments, data may be presented in graphical representations, such as visual representations, such as charts and graphs, where appropriate, to allow the user to comfortably review the large amount of data and to take advantage of humans’ particularly strong pattern recognition abilities related to visual stimuli. In some embodiments, the system may present aggregate quantities, such as totals, counts, and averages. The system may also utilize the information to interpolate or extrapolate, e.g. forecast, future developments.

Further, the interactive and dynamic user interfaces described herein are enabled by innovations in efficient interactions between the user interfaces and underlying systems and components. For example, disclosed herein are improved methods of receiving user inputs, translation and delivery of those inputs to various system components, automatic and dynamic execution of complex processes in response to the input delivery, automatic interaction among various components and processes of the system, and automatic and dynamic updating of the user interfaces. The interactions and presentation of data via the interactive user interfaces described herein may accordingly provide cognitive and ergonomic efficiencies and advantages over previous systems.

Various embodiments of the present disclosure provide improvements to various technologies and technological fields. For example, as described above, existing data storage and processing technology (including, e.g., in memory databases) is limited in various ways (e.g., manual data review is slow, costly, and less detailed; data is too voluminous; etc.), and various embodiments of the disclosure provide significant improvements over such technology. Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, and presentation of the updates to displayed images via interactive graphical user interfaces. Such features and others (e.g., processing and analysis of large amounts of electronic data including point cloud data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

An aspect of the present disclosure relates to a computerized method, performed by a computing system having one or more hardware computer processors and one or more non-transitory computer readable storage device storing software instructions executable by the computing system to perform the computerized method comprising: accessing from memory a first point cloud scan; providing a user interface displaying at least a portion of the first point cloud scan; receiving selection from a user of a first object in the first point cloud scan displayed by the user interface; receiving selection of a three-dimensional tag container; placing the three-dimensional tag container at the selected first object in the first point cloud scan displayed by the user interface; searching for an association of the selected first object with one or more data objects and identifying an association of the selected first object with at least a first data object; and rendering a link graph graphically depicting the association of selected first object with the first data object.

Optionally, the tag container comprises a textual tag indicating an object type. Optionally, the first data object comprises an entity, event, or document. Optionally, the user interface comprises a resolution control configured to enable a user to change a resolution of the first point cloud scan in the user interface. Optionally, the user interface and the first point cloud scan are rendered by a browser client of a user computing system, and wherein the user interface is configured to enable the user to rotate the point cloud scan rendered by the browser. Optionally, the user interface and the first point cloud scan are rendered by an augmented reality or virtual reality headset. Optionally, the method further comprises processing a two-dimensional image to generate the first point cloud scan. Optionally, the method further comprises: performing object recognition on the first point cloud and identifying objects in the first point cloud; and identifying tag containers for one or more of the identified objects using the identification of the objects. Optionally, the method further comprises: determining a distance of the first object to a second object in the first point cloud; and storing the distance of the first object to the second object in memory. Optionally, the method further comprises: receiving a search query comprising a request to identify objects within a specified distance of the first object in one or more point cloud scans; identifying objects within the specified distance of the first object in one or more point cloud scans; and providing search results comprising the identification of objects within the specified distance of the first object in one or more point cloud scans.

An aspect of the present disclosure relates to a computing system comprising: a hardware computer processor; a non-transitory computer readable medium having software instructions stored thereon, the software instructions executable by the hardware computer processor to cause the computing system to perform operations comprising: accessing from memory a first point cloud scan; providing a user interface displaying at least a portion of the first point cloud scan; receiving selection from a user of a first object in the first point cloud scan displayed by the user interface; receiving selection of a three-dimensional tag container; placing the three-dimensional tag container at the selected first object in the first point cloud scan displayed by the user interface; searching for an association of the selected first object with one or more data objects and identifying an association of the selected first object with at least a first data object; and rendering a link graph graphically depicting the association of selected first object with the first data object.

Optionally, the tag container comprises a textual tag indicating an object type. Optionally, the first data object comprises an entity, event, or document. Optionally, the user interface comprises a resolution control configured to enable a user to change a resolution of the first point cloud scan in the user interface. Optionally, the user interface and the first point cloud scan are rendered by a browser client of a user computing system, and wherein the user interface is configured to enable the user to rotate the point cloud scan rendered by the browser. Optionally, the user interface and the first point cloud scan are rendered by an augmented reality or virtual reality headset. Optionally, the operations further comprise processing a two-dimensional image to generate the first point cloud scan. Optionally, the operations further comprise: performing object recognition on the first point cloud and identifying objects in the first point cloud; and identifying tag containers for one or more of the identified objects using the identification of the objects. Optionally, the operations further comprise: determining a distance of the first object to a second object in the first point cloud; and storing the distance of the first object to the second object in memory. Optionally, the operations further comprise: receiving a search query comprising a request to identify objects within a specified distance of the first object in one or more point cloud scans; identifying objects within the specified distance of the first object in one or more point cloud scans; and providing search results comprising the identification of objects within the specified distance of the first object in one or more point cloud scans.

Additional embodiments of the disclosure are described below in reference to the appended claims, which may serve as an additional summary of the disclosure.

In various embodiments, systems and/or computer systems are disclosed that comprise a computer readable storage medium having program instructions embodied therewith, and one or more processors configured to execute the program instructions to cause the one or more processors to perform operations comprising one or more aspects of the above- and/or below-described embodiments (including one or more aspects of the appended claims).

In various embodiments, computer-implemented methods are disclosed in which, by one or more processors executing program instructions, one or more aspects of the above- and/or below-described embodiments (including one or more aspects of the appended claims) are implemented and/or performed.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above- and/or below-described embodiments (including one or more aspects of the appended claims).

### BRIEF DESCRIPTION OF THE DRAWINGS

FIG. 1 is a block diagram illustrating an example embodiment of a tagging system in communication with various other systems and components.

FIG. 2 illustrates one embodiment of a database system using an ontology.

FIG. 3 illustrates a sample user interface using relationships described in a data store using a dynamic ontology.

FIG. 4 illustrates an example process of enabling tags and tag containers to be added to a point cloud model.

FIG. 5 illustrates an example process of generating a link graph.

FIG. 6 illustrates a computer system with which certain methods discussed herein may be implemented.

FIGS. 7A-7J illustrate example user interfaces.

### DETAILED DESCRIPTION

### Overview

An aspect of the present disclosure relates to systems and methods configured to ingest point cloud scans, enable tagging of objects within the point cloud scan using a three-dimensional tag container, identify a tagged object that is present in different items (e.g., text, two-dimensional images, and/or point cloud models), and generate a link graph graphically showing the linked relationships of items associated with a common object.

To facilitate an understanding of the systems and methods discussed herein, a number of terms are described below. The terms described below, as well as other terms used herein, should be construed to include the provided descriptions, the ordinary and customary meaning of the terms, and/or any other implied meaning for the respective terms. Thus, the descriptions below do not limit the meaning of these terms, but only provide exemplary descriptions.

A data store can be any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

A database can be any data structure (and/or combinations of multiple data structures) for storing and/or organizing data, including, but not limited to, relational databases (e.g., Oracle databases, PostgreSQL databases, etc.), non-relational databases (e.g., NoSQL databases, etc.), in-memory databases, spreadsheets, as comma separated values (CSV) files, eXtensible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores.

A data object, or object, can be a data container for information representing specific things in the world that have a number of definable properties. For example, a data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object’s attributes (e.g. metadata about the object) may be represented in one or more properties.

A link can be a connection between two data objects, based on, for example, a relationship, an event, and/or matching properties. Links may be directional, such as one representing a payment from person A to B, or bidirectional.

A link set can be a set of multiple links that are shared between two or more data objects.

An object type can be a type of a data object (e.g., Person, Event, or Document). Object types may be defined by an ontology and may be modified or updated to include additional object types. An object definition (e.g., in an ontology) may include how the object is related to other objects, such as being a sub-object type of another object type (e.g. an agent may be a sub-object type of a person object type), and the properties the object type may have.

An ontology can be stored information that provides a data model for storage of data in one or more databases. For example, the stored data may comprise definitions for data object types and respective associated property types. An ontology may also include respective link types/definitions associated with data object types, which may include indications of how data object types may be related to one another. An ontology may also include respective actions associated with data object types. The actions associated with data object types may include, by way of non-limiting example, defined changes to values of properties based on various inputs. An ontology may also include respective functions, or indications of associated functions, associated with data object types, which functions, e.g., may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types.

A point cloud can be a set of data points in a 3D coordinate system (e.g., XYZ axes), where a given point represents a spatial measurement on an object's surface. Point cloud data points may represent the shape and attributes of a real-world object or environment.

Properties can be attributes of a data object that represent individual data items. At a minimum, each property of a data object has a property type and a value or values.

A property type can be the type of data a property is, such as a string, an integer, or a double. Property types may include complex property types, such as a series data values associated with timed ticks (e.g. a time series), etc.

A property values can be the value associated with a property, which is of the type indicated in the property type associated with the property. A property may have multiple values.

A tag can be a keyword or label (e.g., a descriptive keyword or label) assigned to an item of content (such as a point cloud, image, video, article, or dataset) or an object in an item of content (e.g., a couch, a pen, a vehicle, a stop sign, and the like) to enable it to be categorized, identified, and/or organized. Tags may be utilized to enhance searchability by providing metadata that describes the subject, context, and/or or attributes. Three-dimensional container objects may be utilized to specify an object and to associate a tag to the object.

Tagging can include assigning a tag, either manually or via an automated tagging component, to an item of content or a selected portion of data, such as an object in a point cloud or two-dimensional image, words in a document or image, or the like.

An aspect of the present disclosure relates to systems and methods of ingesting point cloud scans (sometimes referred to as point cloud models or point clouds herein), selectively tagging (e.g., ontology tagging) objects within a point cloud model using a graphical three-dimensional container, identifying a tagged object that is present in different items (e.g., text, two-dimensional images, and/or point cloud models), and generating a link graph showing the linked relationships of items associated with a common object.

Such tagging of point cloud models enables various discovery operations to be performed. For example, the objects that appear in a point cloud scene may be identified. Additionally, proximity searches may be enabled. By way of example, objects that appear near (e.g., within a threshold range) a specified object in a plurality of points clouds may be identified. By way of yet further example, given a specified set of objects, point clouds where the set of objects appear may be identified. By way of further example, a determination may be made for a given object as to what point cloud scans, text documents, and/or two-dimensional images the object appears in or is referred to.

Further, rather than just placing an object container around an object, a given tag may be linked back to specific instances of ontologized data. For example, a road sign with a “road sign” tag, the road sign tag may be linked back to specific instances of ontologized data (e.g., “This is the road sign at the corner of 5th avenue and 5th Ave & E 61st St”).

A user interface may be rendered enabling a user to place a three-dimensional tag container (e.g., a cube, a cuboid, a prism, a pyramid, a cylinder, a code, a sphere, a free form container, any combination thereof, or the like) so as to enclose a user-selected object. The user interface may enable the user to select an object in a point cloud model, select a tag container, and the tag container may be automatically placed at the selected object. The user interface may enable the user to drag and drop the object container to a desired location and may enable the user to modify the size of the object container via a drag operation performed on a container handle, vertex, or edge.

An aspect of the present disclosure relates to enhanced techniques for adding tags. Object recognition may be performed to identify objects within a given point cloud scan. In response to a user selecting an object in a point cloud scan user interface, a corresponding suitable object container may be presented. Optionally, the object container may be sized and/or shaped to completely contain the object.

An aspect of the present disclosure relates to enabling a browser, which conventionally has great difficulty in rendering a manipulable point cloud, to be able to render a manipulable point cloud. Rendering a manipulable point cloud in a web browser is challenging for several reasons, such as the complexity of handling large datasets, browser rendering performance, and the limitations of web technologies. In particular, point clouds may consist of millions of points, each with spatial coordinates and potentially additional attributes such as color, intensity, or surface normal (vectors perpendicular to the tangent plane line at a particular point on the surface of an object). Transferring and processing such large datasets over the web is bandwidth-intensive. Further, browsers have limited memory compared to native applications, making them unable to adequately and quickly load and manage large point clouds. In order to overcome such technical challenges, a user interface is provided that enables a user to dynamically change the number of points in the point cloud rendered by a browser hosted on a user system.

The user interface may enable the point cloud view to be rotated to bring different objects in the point cloud to the foreground to enhance the ability to add three-dimensional tags to the object. For example, when rotating a point cloud so as to bring to the fore an object over which an object container is to be placed, a user may instruct, via the user interface, that the number of points rendered by the browser be reduced (e.g., by 50%, 75%, 90%, or other percentage, such as between 1%-99%). Decimation may be performed to simplify the level of detail (LOD) of the objects in the point cloud model. This reduced number of points may greatly facilitate the browser’s ability to render the point cloud and to enable the user to manipulate the rendered point cloud (e.g., to rotate the point cloud) and add an object container to the point cloud. The user may then instruct, via the user interface, for the resolution of the rendered point cloud to be increased to show additional points.

To further enhance the ability to effectively and efficiently add object containers and associated tags to objects in a point cloud, the point cloud and associated user interfaces may be rendered using a virtual reality (VR) or augmented reality (AR) headset. VR/AR enables a user to virtually step into the point cloud, offering a sense of scale and spatial understanding superior to that provided with traditional displays. The use of VR/AR provides enhanced interactivity with respect to rotating the point cloud, scaling the point cloud, selecting objects in the point cloud, adding three-dimensional object containers to objects in the point cloud, moving and/or changing the size of the three-dimensional object containers, adding tags to objects, and/or the like. In addition, VR/AR provides a better user understanding of spatial relationships of objects and/or environments in the three-dimensional point cloud.

In order to quickly and efficiently render a point cloud in a VR/AR headset, certain technical solutions may be utilized. For example, the level of detail may be reduced by reducing the number of points rendered by the VR/AR based on the virtual distance from the user, where the further the distance the fewer the points that will be rendered. By way of further example, simplified representations (e.g., representing an object using an outline of an object rather than rendering a point cloud of the surface of the object) for distant areas may be utilized to reduce GPU (Graphics Processor Unit) load. By way of additional example, a relatively low resolution point cloud may be rendered by the headset, and in response to detecting the user focusing on an object or area (e.g., as determined via eye tracking, headset orientation/head tracking, controller raycasting, field of view analysis, user interactions with a given object, and/or the like), that object or area may be rendered in higher resolution, with more points. Spatial partitioning may be performed, where the point cloud is divided into smaller chunks and only the parts visible to the user are rendered.

In order to obtain the benefits of a point cloud even when the source data is a two-dimensional image or a set of images (as may be the case where the creator of the image does not have access to a device with a LiDAR sensor), the two-dimensional image(s) may be converted to a point cloud image. For example, a COLMAP application (COmputer vision and photogrammetry software with Multi-View stereo and Automatic reconstruction Pipeline) may be utilized to generate a point cloud from a two-dimensional image. Further, video content may be input and transformed into one or more point clouds. Depth and spatial information from the two-dimensional image frames may be extracted and reconstructed as a three-dimensional point cloud representation.

A measurement tool may be provided that measures the distance between objects in a point cloud. For example, if two objects in the point cloud have had object containers placed about them and have been tagged (where the tag may include an identifier), an instruction field may be provided via which a user can input a request such as “what is the distance between ObjectA and ObjectB”. The distance may be determined and rendered on the user display.

Different techniques may be used to calculate the distance between objects in a point cloud. For example, the point-to-point distance may be determined by calculating the Euclidean distance between specific points from the two objects. By way of further example, the point-to-set distance may be determined by calculating the minimum distance from a point in one object to any point in the other object (e.g., for each point in a first object, calculate the distance to all points in a second object and identify the smallest value). By way of additional example, the set-to-set distance may be determined by measuring the minimum distance between two sets of points of respective objects. By way of yet further example, the centroid distance may be determined between the centroids (geometric centers) of two objects in the point cloud (where the centroid of each object is determined and the Euclidean distance between the two centroids is determined). By way of additional example, the average distance may be determined, wherein the average distance between corresponding points or all points in both objects is determined, thereby providing an aggregate measure of separation.

Optionally, a user interface may be provided via which a user may specify the type of distance determination that should be used (e.g., via a menu).

Certain aspects will now be described with reference to the figures.

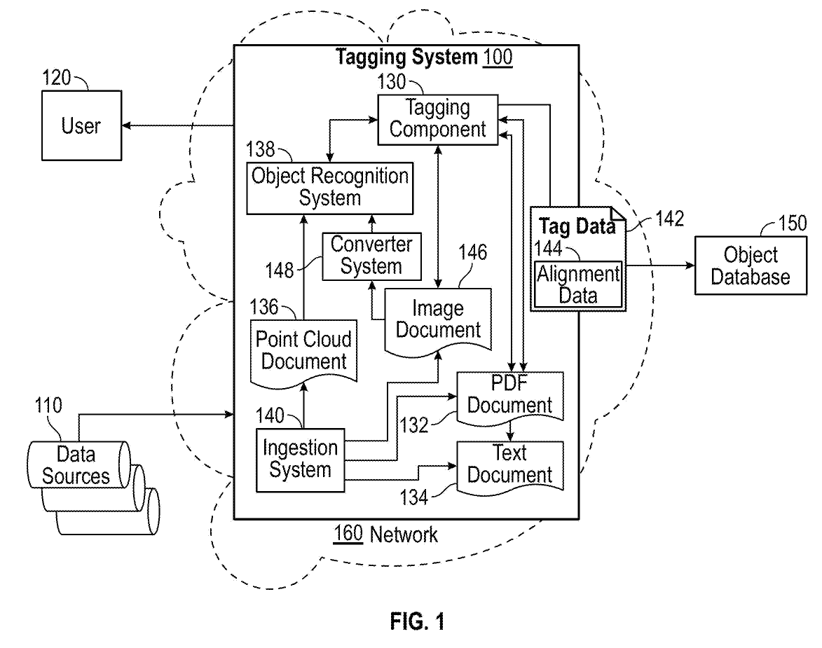

FIG. 1 is a block diagram illustrating an example embodiment of a tagging system 100 in communication with various other systems and components via a network 160. In this example, the tagging system 100 is configured to access data of various formats, such as cloud point models, two-dimensional image content, and text documents, and to enable tagging of portions of the data, such as objects in a point cloud or two-dimensional image, or selected text in a text document. In the example of FIG. 1, tagging system 100 includes an ingestion engine 140 configured to access, process, parse, analyze, etc. various forms of data that are of interest from data sources 110. For example, the ingestion engine may identify properties of documents, such as document name, type, source, keywords, metadata, related documents, and/or the like that are then stored in object database 150, such as in a hierarchical relationship according to a defined ontology. By way of example, data sources 110 may include point cloud scan data sources, such as LiDAR equipped devices (e.g., mobile phone, tablets, vehicles, game consoles, and the like).

In the example of FIG. 1, a user 120 (e.g., an individual operating a computing device and/or the user computing device) interfaces with the tagging system 100, such as to view various documents that are received by the ingestion engine 140. For example, the user 120 may view a PDF document 132, a text document 134, a point cloud scan 136, and/or a two-dimensional image document 146 (e.g., a photograph, a graphic, and/or the like).

A converter system 148 may be configured to convert the two-dimensional image document 146, sets of images, and/or videos to corresponding point cloud models. For example, as described elsewhere herein, a COLMAP application may be utilized by the converter system 148 to generate a point cloud from a two-dimensional image. Further, video content may be input and transformed into one or more point clouds. Depth and spatial information from the two-dimensional image frames may be extracted and reconstructed as a three-dimensional point cloud representation.

The converter system may be configured to convert point cloud models to two-dimensional images. For example, converting a point cloud to a two-dimensional image may comprise projecting the three-dimensional data of the point cloud onto a two-dimensional plane, optionally using viewpoint specifications defining the position, orientation, and characteristics of a virtual camera or observer to simulate how the scene would appear from a particular perspective.

One problem that may be presented when a user clicks, taps, or otherwise interacts with the point cloud user interface is slow collision detection. "Slow collision" refers to a scenario where a user's click or tap, intended to interact with a specific element, fails to register or activates the wrong element because of a delay or lag in the system's response to the user’s input. One technique to reduce the occurrence of slow collision detection is to perform downsampling on the point cloud via the converter system. Advantageously, downsampling may also be beneficial with respect to object detection.

For example, in the context of screen collision detection, preprocessing may be performed where the point cloud is downsampled to reduce the number of points, thereby reducing computational load by reducing the number of points that need to be checked, simplifying the collision detection process and enabling faster and more efficient collision detection. Optionally, in addition or instead, invisible polygons may be surface-fit onto the point cloud and may be used for collision detection.

Similarly, in order to perform recognition of objects in a point cloud model, preprocessing may be performed where the point cloud is downsampled to reduce the number of points while still maintaining sufficient point data to identify objects. Such downsampling advantageously reduces the amount of processing power and time needed to perform object recognition. In addition, noise reduction may be performed. For example, points that are more than a threshold distance away from other points (indicating that they are not associated with an object and may simply be noise) may be removed. Segmentation may be performed on the preprocessed point cloud to divide the point cloud into smaller, meaningful regions. For example, clustering or surface fitting to isolate objects. Features such as geometric descriptors (e.g., curvature, normal vectors, and/or the like) or learned embeddings from deep learning models (e.g., using PointNet, a neural network used for semantic segmentation of unorganized LiDAR point clouds) may be extracted to characterize these regions. Feature matching or classification may then be performed by comparing descriptors against known models or using a trained neural network to recognize patterns in the point cloud. Optionally, contextual information, such as spatial relationships or prior knowledge about object arrangements, may be utilized to improve the accuracy of the object recognition.

In some instances, the point cloud scan 136, the two-dimensional image document 146, and the PDF document 132 include the same content, but in different, respective file formats. In some instances, the PDF document 132 and text document 134 include the same content, but in different file formats. For example, the PDF document 132 is an image-based document format that may include images, graphics, columns, headers, footers, indentations, headings, etc. that are not included in the corresponding text document 134.

In order to facilitate tagging of the point cloud scan 136, an object recognition system 138 may be utilized to identify objects in point cloud scans and in point cloud models generated from the two-dimensional image documents 146, generate corresponding suggested tags, and generate or select corresponding object containers.

To reduce the amount of processing power utilized and the time it takes to perform object recognition, rather than attempting to recognize all objects in a point cloud, a user interface may be provided (e.g., a menu) via which a user can specify what objects are to be recognized. For example, a user may specify that vehicles, stop signs, or curbs are to be recognized. The object recognition system 138 may then determine whether iteratively identified characteristics of a given object in the point cloud correspond to those which are typically found or not found in the selected object types that are to be recognized. In response to determining that the object has a threshold number of types of characteristics that are incompatible with the selected object types, or is missing characteristics that are typically found in the selected object types the object recognition system 138 may exclude the object from further object recognition processing.

In some circumstances, the user 120 may wish to view and tag content of a point cloud model rather than a corresponding two-dimensional image-based document, while in other circumstances the user 120 may wish to view and tag the two-dimensional image-based document rather than the corresponding point cloud model. The tagging component 130 is configured to enable the user to interface with either (or both) two-dimensional image document and point cloud model and to automatically create and synchronize tags between the two versions.

In the example of FIG. 1, the tagging component 130 provides tag data 142, such as information regarding content of each of the PDF document 132 and corresponding text document 134 associated with the tag, as well as alignment data 144 indicating a relationship between the tagged portions of each of the point cloud scan 136 and the two-dimensional image document 146 and each of the PDF document 132 and text document 134. The tag data 142 may be stored in object database 150, which may be organized according to an ontology such as to include objects that are associated with one another via links.

### Object-Centric Data Model

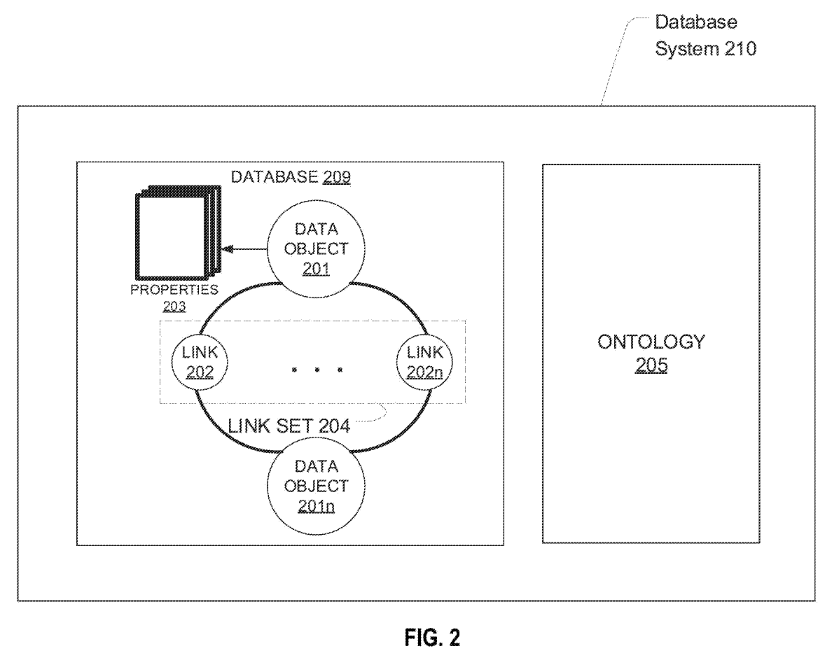

With reference to FIG. 2, to provide a framework for the following discussion of specific systems and methods described herein, an example database system 210 using an ontology 205 will now be described. This description is provided for the purpose of providing an example and is not intended to limit the techniques to the example data model, the example database system, or the example database system’s use of an ontology to represent information.

By way of example, a body of data is conceptually structured according to an object-centric data model represented by ontology 205. The conceptual data model may be independent of any particular database used for durably storing one or more database(s) 209 based on the ontology 205. For example, each object of the conceptual data model may correspond to one or more rows in a relational database or an entry in Lightweight Directory Access Protocol (LDAP) database, or any combination of one or more databases.

The ontology 205, as noted above, may include stored information providing a data model for storage of data in the database 209. The ontology 205 may be defined by one or more object types, which may each be associated with one or more property types. At the highest level of abstraction, data object 201 is a container for information representing things in the world. For example, data object 201 can represent an entity such as a person, a place, an organization, a market instrument, or other noun. Data object 201 can represent an event that happens at a point in time or for a duration. Data object 201 can represent a document or other unstructured data source such as an e-mail message, a news report, or a written paper or article. Each data object 201 is associated with a unique identifier that uniquely identifies the data object within the database system.

Different types of data objects may have different property types. For example, a “Vehicle” data object might have a “License plate” property type and an “Person” data object might have a “Name” property type. Properties 203, as respectively represented by data in the database system 210, may have a corresponding property type defined by the ontology 205 used by the database.

Objects may be instantiated in the database 209 in accordance with the corresponding object definition for the particular object in the ontology 205. For example, a specific house (e.g., an object of type “building”) at 2001 Acme Street (e.g., a property of type “street address”) from a point cloud captured on 1/1/2025 (e.g., a property of type “date”) may be stored in the database 209 as an building object with associated property and date properties as defined within the ontology 205. The data objects defined in the ontology 205 may support property multiplicity. In particular, a data object 201 may be allowed to have more than one property 203 of the same property type. For example, a “Person” data object might have multiple “Address” properties or multiple “Name” properties.

A given link 202 represents a connection between two data objects 201. For example, the connection may be through a relationship, an event, or through matching properties. A relationship connection may be asymmetrical or symmetrical. For example, “Person” data object A may be connected to “Person” data object B by a “Child Of” relationship (where “Person” data object B has an asymmetric “Parent Of” relationship to “Person” data object A), a “Kin Of” symmetric relationship to “Person” data object C, and an asymmetric “Member Of” relationship to “Organization” data object X. The type of relationship between two data objects may vary depending on the types of data objects. For example, “Person” data object A may have an “Appears In” relationship with “Point Cloud” data object Y or have a “Participate In” relationship with “Event” data object E. As an example of an event connection, two “Person” data objects may be connected by a “House” data object representing a particular house if they both resided at the house, or by a “Vehicle” data object representing a particular vehicle if they both travelled via the same vehicle. By way of example, when two data objects are connected by an event, they are also connected by relationships, in which each data object has a specific relationship to the event, such as, for example, an “Appears In” relationship.

As an example of a matching properties connection, two “Person” data objects representing a brother and a sister, may both have an “Address” property that indicates where they live. If the brother and the sister live in the same home, then their “Address” properties likely contain similar, if not identical property values. In certain instances, a link between two data objects may be established based on similar or matching properties (e.g., property types and/or property values) of the data objects. These are just some examples of the types of connections that may be represented by a link and other types of connections may be represented; embodiments are not limited to any particular types of connections between data objects. For example, a document might contain references to two different objects. By way of illustrative example, a point cloud of a scene may contain a person (one object), and a phone (a second object). A link between these two objects may represent a connection between these two entities through their co-occurrence within the same environment.

A given data object 201 can have multiple links with another data object 201 to form a link set 204. For example, two “Vehicle” data objects representing two cars could be linked through an “Accident” event and a matching “Address” property corresponding to where the accident took place. A given link 202 as represented by data in a database may have a link type defined by the database ontology used by the database 209.

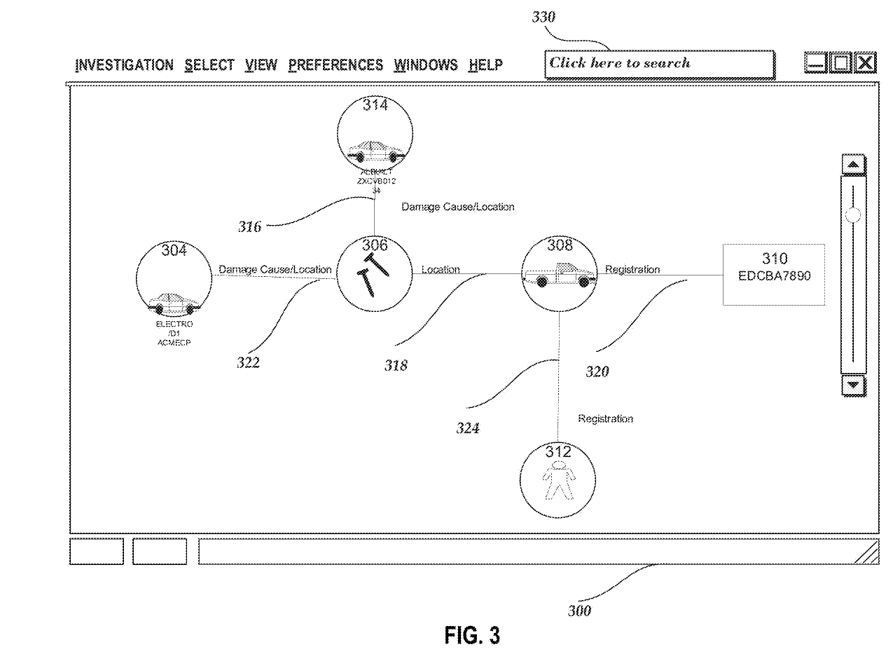

The properties, objects, and links (e.g. relationships) between objects can be visualized using a graphical user interface (GUI). Certain objects may be identified and tagged in one or more point cloud models, such as those described elsewhere herein. For example, FIG. 3 displays a user interface showing a graph representation 300 of relationships between the data objects that are represented as nodes. In this example, the data objects include car objects 304, 314, nail object 306, truck object 308, license plate object 310, and person object 312. Optionally, each node may have relationships and/or links with any of the other nodes through, for example, other objects such as vehicle registration objects. As will be explained, in this example the linked relationship indicates tire damage was caused to two different cars at two different locations by the same nail types. A truck was also present at both accident locations at about the time of the accidents, indicating the truck may be the source of the nails. The truck is associated with an owner and a license plate identifier.

For example, in FIG. 3, relationship 322 is based on a damage caused by the nail object 306 to the tires of the car object 304 and a first common location/address where the tire damage occurred. Relationship 316 is based on damage caused by the nail object 306 to the tires of the car object 314 and a second common location/address. Relationship 318 is based on the presence of the truck object 308 at the first common location and at the second common location.

Relationship 320 is based on a registration of the truck object 308 and the license plate object 310. Relationship 324 is based on the registration of the truck object 308 and the person object 312.

Relationships between data objects may be stored as links, or as properties, where a relationship may be detected between the properties. In some cases, the links may be directional. For example, a damage link may have a direction associated with the damage, where one object (e.g., nails) is the cause of the damage, and vehicle object suffered the damage.

In addition to visually showing relationships between the data objects, the user interface may allow various other manipulations. For example, the objects within database 150 may be searched using a search interface 330 (e.g., text string matching of object properties), inspected (e.g., properties and associated data viewed via user interfaces described herein), filtered (e.g., narrowing the universe of objects into sets and subsets by properties or relationships), and statistically aggregated (e.g., numerically summarized based on summarization criteria), among other operations and visualizations. Optionally, the user interface may enable the user to edit links, properties, relationships, and the like. For example, the user interface may include link delete and add tools which enable the user to delete links between objects and add links between objects. The link edit tools may enable the user to edit the direction of links. The user interface may also enable a user to add or delete properties associated with objects.

Advantageously, the present disclosure enables users to interact and analyze electronic data in a more analytically useful way. Graphical user interfaces allow the user to visualize otherwise obscure relationships and patterns between different data objects. The present disclosure allows for greater scalability by allowing greater access and search capabilities regardless of size. Without using the present disclosure, observation and use of such relationships would be virtually impossible given the size and diversity of many users’ present databases, (e.g., spreadsheets, emails, and word processing documents).

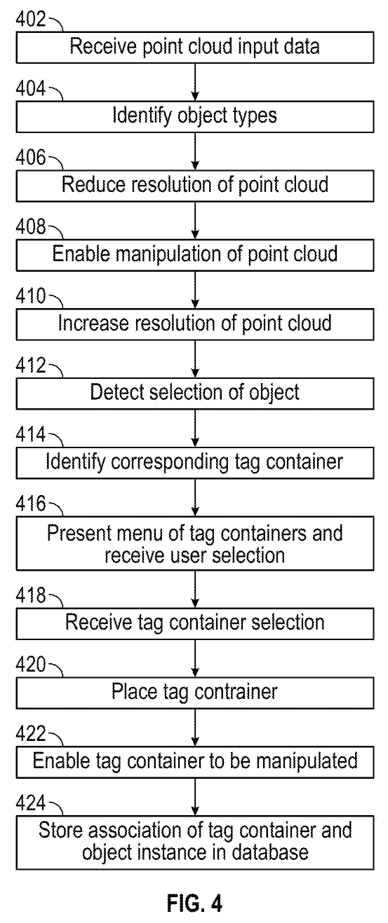

FIG. 4 illustrates an example process for enabling tags and tag containers to be added to a point cloud model imaged on a user system display.

At block 402, point cloud input data comprising a point cloud scan is received. For example, the point cloud data may be received as a scan from a LiDAR equipped device, such as a mobile phone, tablet, or the like. The point cloud input data may be stored in and accessed from a database.

At block 404, object types in the point cloud data may optionally be automatically recognized and optionally corresponding tags may be automatically selected or suggested to a user. For example, as similarly discussed above, to reduce the amount of processing power utilized and the time it takes to perform object recognition, rather than attempting to recognize all objects in a point cloud data, the object recognition process only attempts to recognize certain types of objects, such as user specified object types. The object recognition process may determine whether the characteristics of a given object in the point cloud data correspond to those which are typically found or not found in the selected object types that are to be recognized. In response to determining that an object has characteristics that are incompatible with the selected object type(s), or is missing characteristics that are typically found in the selected object type(s), such objects from further object recognition processing and may not be identified as a specific object type.

Optionally, to reduce the processor bandwidth utilization, memory utilization, and processing time needed to perform objection recognition, the point cloud data is downsampled to reduce the number of points while still maintaining sufficient point data to identify objects. Noise reduction may optionally be performed, where points that are more than a threshold distance away from other points are removed. Segmentation may be performed to divide the point cloud data into smaller, meaningful regions. Such regions may be characterized using, for example, geometric descriptors and/or learned embeddings from deep learning models. Feature matching or classification may then be performed by comparing descriptors against known models or using a neural network to recognize patterns in the point cloud. Optionally, contextual information, such as spatial relationships or prior knowledge about object arrangements, may be utilized to improve the accuracy of the object recognition.

Once an object is recognized, one or more corresponding textual descriptors may be assigned to the object and may be stored in association with position information corresponding to the position of the object in the point cloud scan. For example, an object ID and a textual descriptor may be stored in an external file (e.g., JSON, XML, or a database. Unique cluster identifiers (e.g., bounding boxes, indices, or spatial extents) may be utilized to link objects in the point cloud with their associated metadata. The point cloud data and object associations may be stored in a spatial database (e.g., PostgreSQL with PostGIS), and spatial indexing to associate points or clusters with object IDs and/or descriptive text.

At block 406, the point cloud scan is rendered on a user device. Optionally, the point cloud scan may be transmitted to and rendered by a browser client on a user computing system. As similarly discussed elsewhere herein, a browser conventionally has great difficulty in rendering a manipulable point cloud which may contain millions of points, each with spatial coordinates and potentially additional attributes such as color, intensity, or surface normal. To overcome such technical challenges, the user interface presented via the browser may include a control, such as a slider, menu, or text field, that enables a user to dynamically decrease (e.g., using decimation) or increase the number of points in the point cloud rendered by the browser.

When the user desires to manipulate the point cloud scan, this reduced number of points may greatly facilitate the browser’s ability to render the point cloud and to enable the user, at block 408, to manipulate the rendered point cloud (e.g., to rotate the point cloud via a rotation gesture or control that enables the point cloud to be rotated in three dimensions) to better view a target object. At block 410, the user may then instruct, via the user interface, that the resolution of the rendered point cloud is to be increased to show additional points and detail.

At block 412, the user may select an instance of an object in the point cloud scan. The selected object, or a portion thereof, may be highlighted (e.g., via an object outline, via a marker, via a color change, or otherwise). At block 414, the object type may be determined from an associated tag or other identifier, such as that determined at block 404. A corresponding tag container may be selected. The tag container may be shaped, proportioned, and/or sized to approximately contain the selected object. A tag container may be automatically dropped onto the selected object, and the user may then drag and drop the container to more precisely encompass the target object, add or edit tags, and perform other operations.

At block 416, a tag container menu may be presented. The presentation of the tag container menu may be dynamically determined so as to place the tag container selected at block 414 at the top or other most prominent position in the tag container, with other available tag containers placed at less prominent positions in the tag container menu.

At block 418, a user selection of a tag container from the tag container menu may be received from the user. At block 420, the tag container may be automatically placed on the selected object in the point cloud scan. At block 422, the user interface enables the user to manipulate the tag container. For example, the tag container may have associated handles or drag locations that the user can point at (e.g., via a cursor, a finger, or otherwise) and perform a drag operation to change the size of the tag container and/or to drag the tag container to a different location. Tag edit controls and fields may be provided that enable the user to edit existing tags (e.g., default tags associated with the tag container) and/or that enables the user to add one or more tags to the tag container via a tag text field.

At block 424, the association of the tag container, associated tags, and the selected object instance may be stored in memory, such as a database, for later use. For example, the tag container and tags may be used to find a match to a user search query. By way of further example, the tag container and tags may be utilized to generate a link graph, such as that illustrated in FIG. 3.

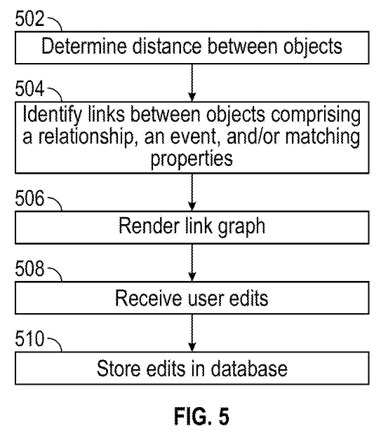

FIG. 5 illustrates an example process for generating a link graph. At block 502, the distance between objects in images, such as two-dimensional images, three-dimensional images, and point cloud scans. Such distance data may be utilized in determining relationships between objects in the images and to respond to search queries (e.g., find all objects within two feet of a phone object). For example, as similarly discussed elsewhere herein, different techniques may be used to calculate the distance between objects in a point cloud. Such techniques may include calculating the Euclidean distance between specific points of two objects, calculating the minimum distance from a point in one object to any point in the other object, measuring the minimum distance between two sets of points of respective objects, determining the distance between the centroids of two objects, and/or determining the average distance between all or large sets of points in both objects.

At block 504, links between objects in a plurality of items may be identified. Such links may comprise relationships, events, matching properties, and/or the like. The direction of links may be determined, where such links are directional. At block 506, a link graph may be generated using the link identification and line direction determinations performed at block 504. The link graph may include nodes, where a given node may have relationships and/or links with other nodes through, for example, other objects.

At block 508, user edits to the link graph are received. For example, the graph link user interface may enable the user to edit links, properties, relationships, and the like. The user interface may include link delete and link add tools which enable the user to delete links between nodes (e.g., objects) and add links between nodes. The link edit tools may enable the user to edit the direction of links. The user interface may also enable a user to add or delete properties associated with nodes.

At block 510, the user edits may be stored in memory for later access.

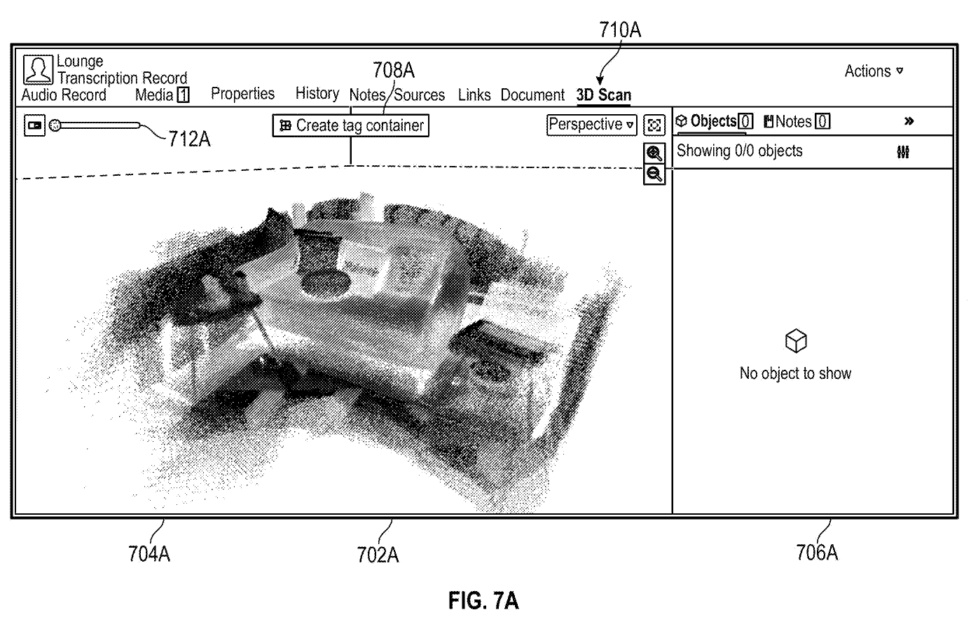

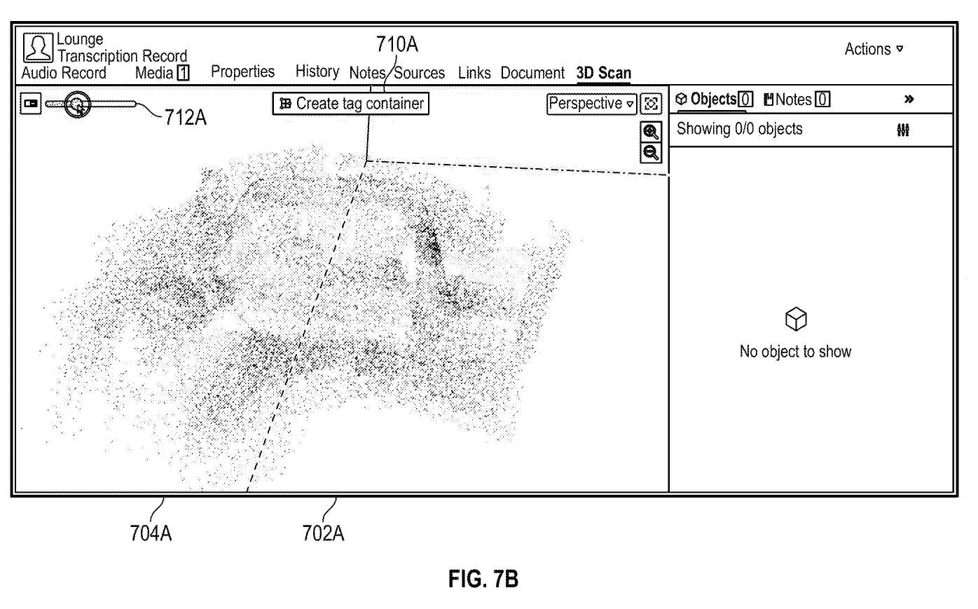

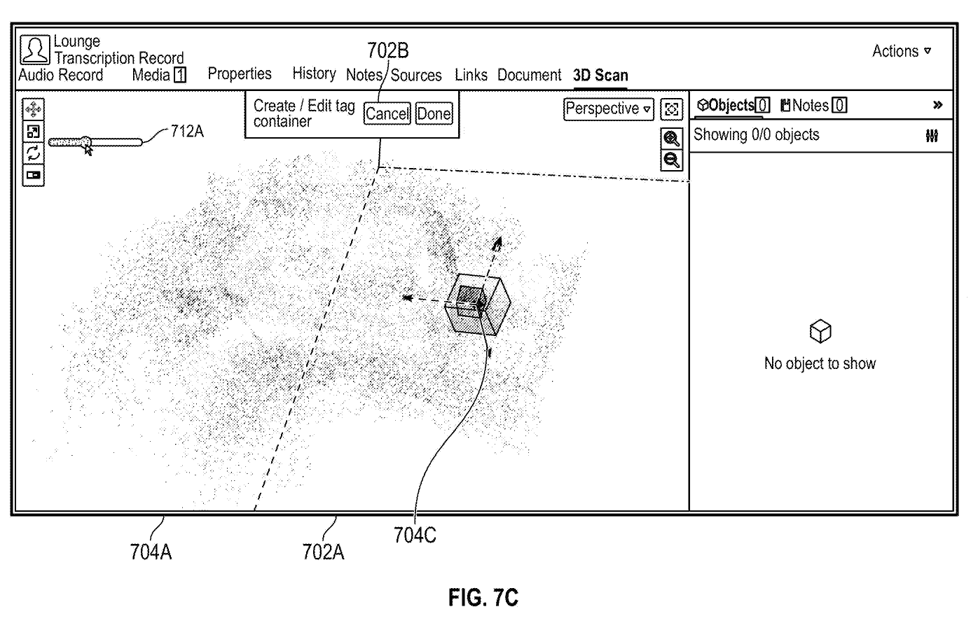

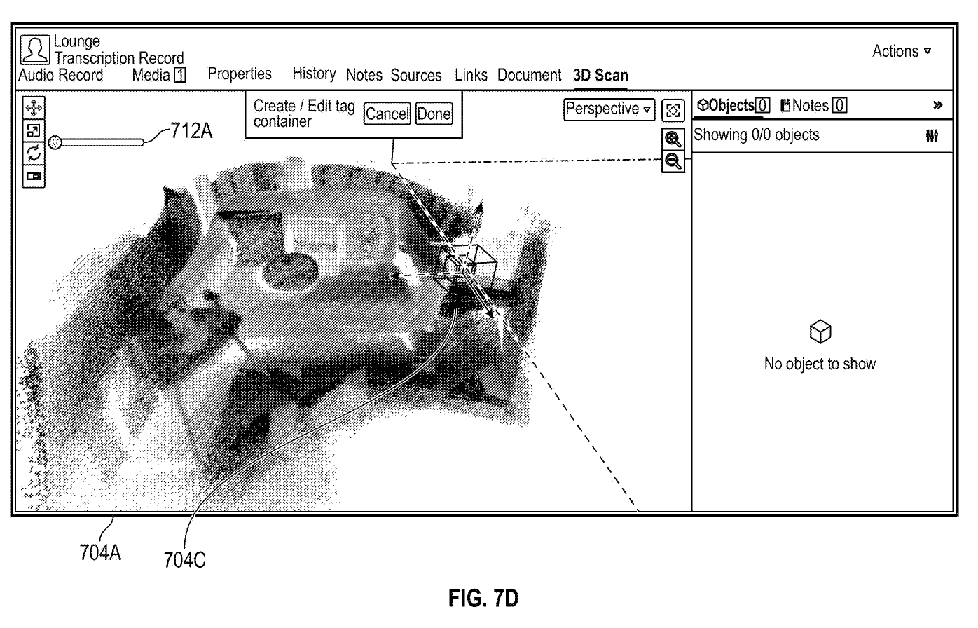

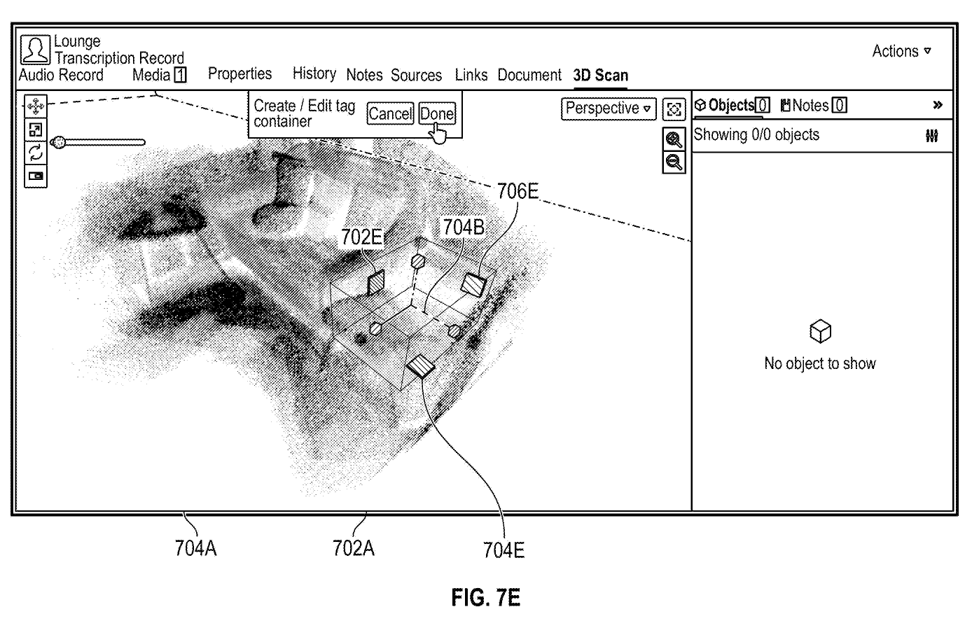

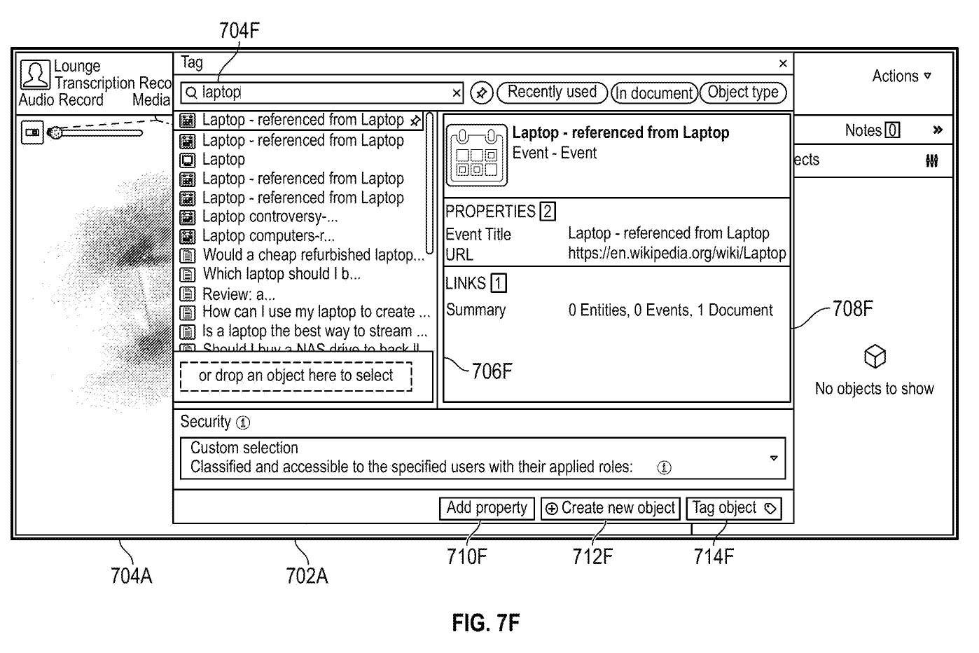

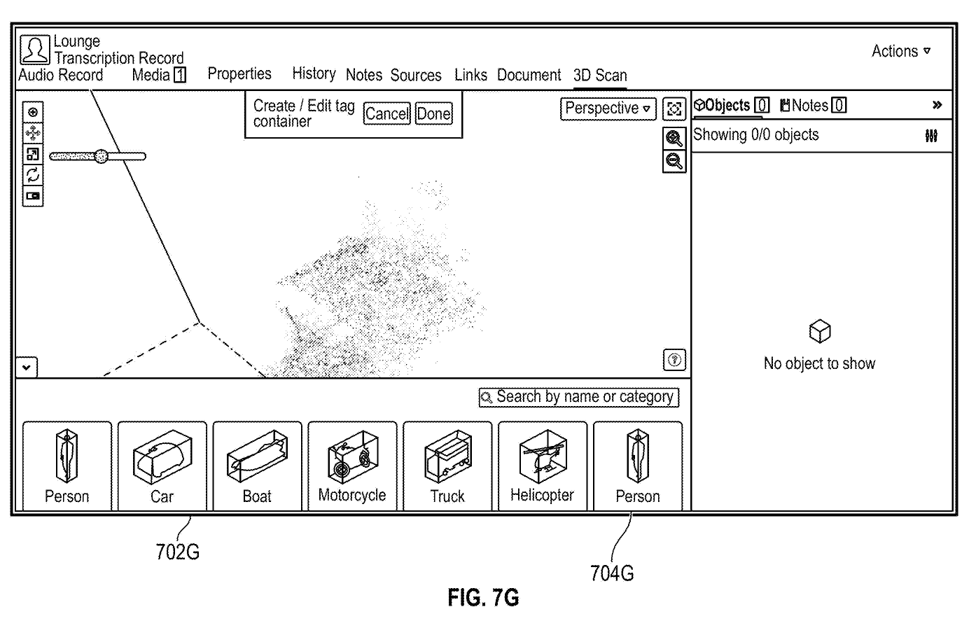

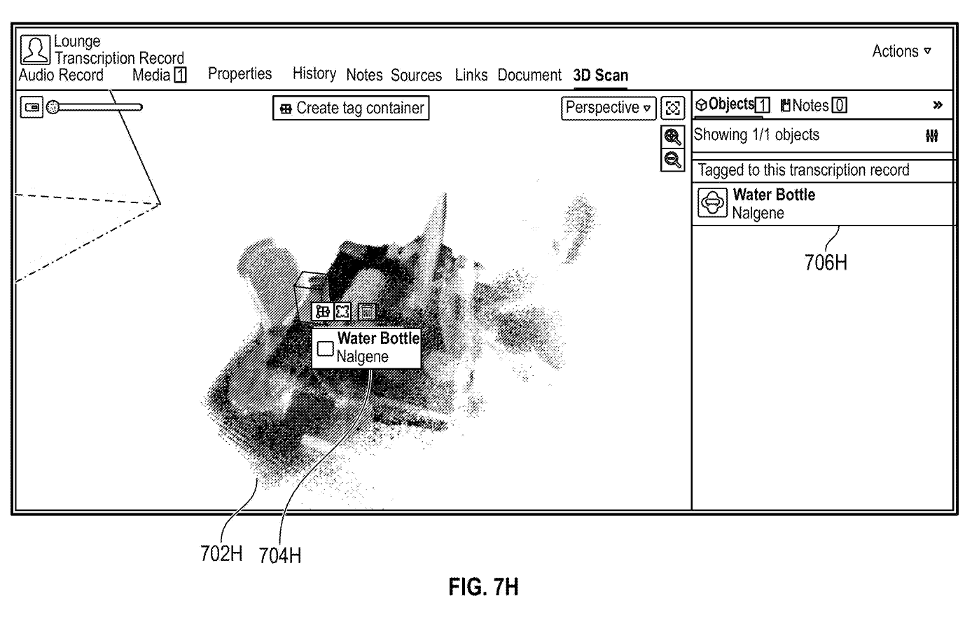

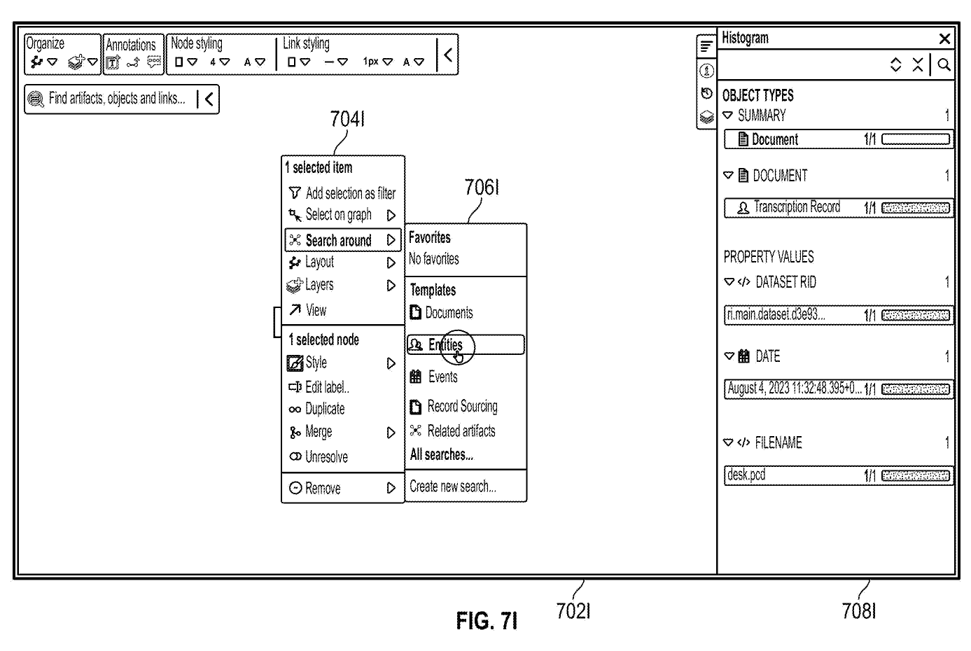

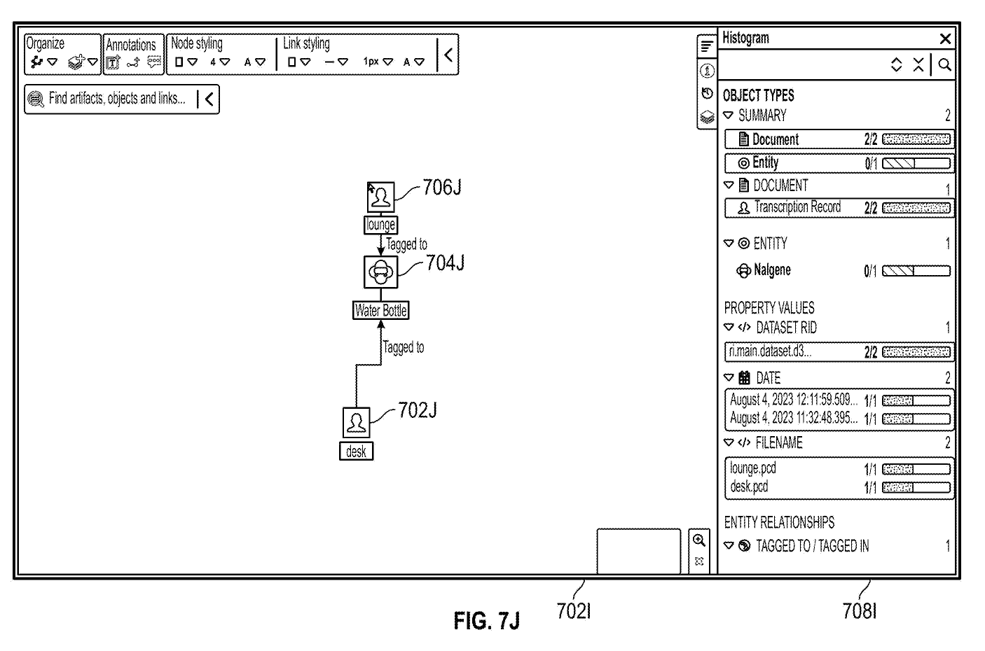

Certain example user interfaces will now be described with reference to the figures. FIG. 7A illustrates a point cloud scan 704A rendered in a user interface 702A by a browser. Pane 706A provides data on a point cloud object selected by a user, where the user may select an object by double clicking on the object or otherwise. In this example, no object has been selected and so no data is presented in pane 706A. A “create tag container” 708A is provided, which when activated causes a user interface (discussed elsewhere herein) to be presented that enables a tag container to be added to an object in the point cloud. A menu is provided via which a user can instruct what data is to be presented via the user interface 702A. The menu selection includes audio record, media 1, properties, history, notes, sources, links, document, and 3D scan 710A (e.g., a point cloud scan). In this example, the 3D scan menu entry is selected, causing the point cloud scan to be presented. A point cloud resolution slider 712A is provided that enables the resolution of the point cloud displayed by the browser to be increased or decreased. For example, as discussed elsewhere herein, the resolution of the point cloud may be decreased to reduce the computer resources needed to manipulate and rotate the point cloud. The point cloud resolution may then be increased to better visualize the objects in the point cloud.

FIG. 7B illustrates the point cloud scan 704A with the point cloud resolution slider 712A adjusted so as to reduce the resolution, wherein fewer points of the point cloud are displayed. FIG. 7C illustrates the user interface of FIG. 7B, with the reduced point cloud resolution, with the create tag container 708A selected to cause the “create/edit tag container” control 702B to be displayed. In this example, a user has selected an object in the point cloud and a three-dimensional tag container 704C is automatically placed and rendered at the selected object. The user may rotate the image using rotation controls or pointer gestures so as to view the point cloud from a desired angle.

Optionally, a “flying camera” mode (sometimes referred to as “free camera” or "flythrough mode") and corresponding controls may be provided, via which the user may reposition the viewport in space (e.g., using the WASD keyboard keys or otherwise) and may pan/tilt the virtual camera (e.g., using mouse or other pointing device). Thus, the "flying camera" provides a navigation tool that enables the user to move through the cloud point 3D scene as if they are flying or walking, offering a first-person perspective, optionally in conjunction with a viewport to display the camera's view. The flying camera mode may provide more intuitive viewport positioning in complex scans, and may be especially beneficial for scans of enclosed spaces.

FIG. 7D illustrates the user interface of FIG. 7C, with the point cloud resolution slider 712A adjusted so as to increase the resolution, with more points of the point cloud displayed. With the resolution increased, the objects and the object borders are sharper and more clearly discernible. The user may then rotate, move, enlarge, shrink, change the proportions, and/or otherwise modify the tag container. For example, handles 702E, 704E, 706E may be utilized to drag the given side of the container to increase or decrease the container size. A tag container may have fewer or additional handles. Optionally, one or more controls may be provided (e.g., buttons on the left side, right side, top, and/or bottom of the user interface) that enable the user to control which handles are visible on the tag container.

FIG. 7E illustrates the point cloud scan 704A in a rotated position. The user may rotate, move, enlarge, shrink, change the proportions, and/or otherwise modify the tag container 708C. For example, handles 702E, 704E, 706E may be utilized to drag the given side of the container to increase or decrease the container size. A tag container may have fewer or additional handles.

FIG. 7F illustrates a tag object search field 704F. As the user enters text into the search field 704F, a search engine incrementally identifies matching tag objects, and provides the search results in real time for display in the search results window 706F. The details of a tag object may be displayed in a tag object details pane 708F. For example, the details may be for the top ranked/first listed tag object in the search results window 706F or a user-selected tag object in the search results window 706F. Such details may include the tag object name, type, properties, links (which may include a link summary comprising linked entities, events, and documents), and the like. An add property control 710F is provided, which when activated by a user enables the user to add properties to the tag object. A create new object control 712F is provided, which when activated by a user enables the user to create and define a new object. A tag object control 714F is provided, which when activated by a user causes the illustrated user interface to be presented.

FIG. 7G illustrates an example user interface via which the user can select a predefined tag container from a library menu of tag containers 702G, wherein a predefined tag container selected by the user is rendered so as to overlay or contain a selected object in the point cloud. The library menu may display the shape and proportions of a given tag container, including the textual name of the object and a graphic of the object. A search field 704G is configured to receive a textual search term from a user. For example, the search term may include a tag container name and/or category. In response, a search engine identifies matching tag containers and may present the matching containers in the library menu of tag containers 702G.

FIG. 7H illustrates an example of a bottle tag container 704H added to a bottle in the point cloud 702H. The bottle tag container 704H is displayed in association with the tag container name (“bottle”) and a brand property. Controls are provided in association with the bottle tag container 704H via which the user can delete the tag container, change the size of the bottle tag container 704H, or change the orientation of the bottle tag container 704H. Pane 706H indicates the objects that are tagged to the corresponding transcription records. In this example, the water bottle object is listed.

FIG. 7I illustrates a menu 704I, overlaying a link graph user interface 702I, via which a user can select among various actions to perform, such as “add a selection filter,” “select on graph,” search around,” “layout,” “layer,” and “view.” In addition, menu selections are provided that enable various actions to be performed with respect to a link graph node, such as editing of the node style, editing of a node label, duplication of a node, merging of nodes, unresolve, and remove. In this example, the search around menu entry has been selected. For example, a search field may be provided via which a user may search around for documents, entities, events, properties, record sourcing, related artifacts, and/or the like. A search engine may identify matches which may be presented to the user via a search user results. interface.

A corresponding waterfall menu 706I is presented via which the user can search around for various templates, such as documents, entities, events, record sourcing, and related artifacts. Information regarding object types may be presented in pane 708I, which may provide a summary comprising an identification of the object type (in this example, a document type), the document type (transcription record in this example), and associated property values, date, and file name).

A search field is provided via which the user can search for documents that are linked to an object, such as a bottle object. Locations (e.g., actual unique locations in the real world, such as a specific lounge, office, restaurant, etc.) may be identified where the bottle object is identified. Thus, the bottle object may be linked to a plurality of identified locations.

FIG. 7J illustrates an example link graph user interface 702I depicting a bottle object 704J graphically linked via a line to a desk object 702J and via a line to a lounge object 706J, indicating that the bottle object 704J was in a point cloud scan of the desk object 702J and a point cloud scan of the lounge object 706J. Information regarding object types may be presented in pane 708I as similarly discussed above with respect to FIG. 7I.

### Example API Module

Various third-parties operate electronic services systems. In some instances, these systems may allow access through Application Programming Interfaces (APIs). Typically, each API requires its own set of information about a data object, such as name, age, and height for a data object representing a person. Advantageously, embodiments of the present disclosure may collect information related to a data object, form API requests in the format and containing the information required by the API of each third-party (“third-party format”), collect responses from the API of each third-party, translate the different results back into a uniform format that facilitates comparison, storage and/or processing (“common format”), and show the results to the user. For example, different third-parties may require different types of information, and in different formats; for example, third-party A may require a data object’s name and age properties, whereas third-party B may require a data object’s age and height properties but not name.

Advantageously, rather than presenting the user with different third-parties’ requests to provide different information repeatedly, the system may retrieve the required information from its database and automatically convert it into the format expected by the third-party. Advantageously, the system may then also convert the individual responses received from each API, which may again be in a third-party-specific format, into a common format that may facilitate comparison by the user. Similarly, various embodiments may use external APIs to access other services.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the "C" programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

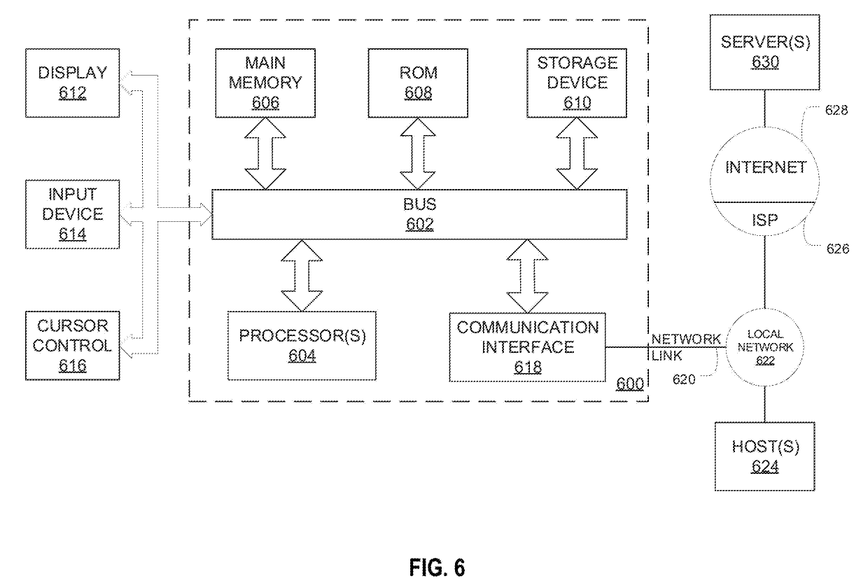

For example, FIG. 6 is a block diagram that illustrates a computer system 600 upon which various embodiments may be implemented. Computer system 600 includes a bus 602 or other communication mechanism for communicating information, and a hardware processor, or multiple processors, 604 coupled with bus 602 for processing information. Hardware processor(s) 604 may be, for example, one or more general purpose microprocessors.

Computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

Computer system 600 may be coupled via bus 602 to a display 612, such as a cathode ray tube (CRT) or LCD display (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 600 may include a user interface module to implement a GUI that may be stored in a mass storage device as computer executable program instructions that are executed by the computing device(s). Computer system 600 may further, as described below, implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more computer readable program instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

Various forms of computer readable storage media may be involved in carrying one or more sequences of one or more computer readable program instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN (or WAN component to communicate with a WAN). Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user’s computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A computerized method, performed by a computing system having one or more hardware computer processors and one or more non-transitory computer readable storage device storing software instructions executable by the computing system to perform the computerized method comprising:
accessing from memory a first point cloud scan;
providing a user interface displaying at least a portion of the first point cloud scan;
receiving selection from a user of a first object in the first point cloud scan displayed by the user interface;
receiving selection of a three-dimensional tag container;
placing the three-dimensional tag container at the selected first object in the first point cloud scan displayed by the user interface;
searching for an association of the selected first object with one or more data objects and identifying an association of the selected first object with at least a first data object; and
rendering a link graph graphically depicting the association of selected first object with the first data object.

2. The computerized method of claim 1, wherein the tag container comprises a textual tag indicating an object type.

3. The computerized method of claim 1, wherein the first data object comprises an entity, event, or document.

4. The computerized method of claim 1, wherein the user interface comprises a resolution control configured to enable a user to change a resolution of the first point cloud scan in the user interface.

5. The computerized method of claim 1, wherein the user interface and the first point cloud scan are rendered by a browser client of a user computing system, and wherein the user interface is configured to enable the user to rotate the point cloud scan rendered by the browser.

6. The computerized method of claim 1, wherein the user interface and the first point cloud scan are rendered by an augmented reality or virtual reality headset.

7. The computerized method of claim 1, the method further comprising processing a two-dimensional image to generate the first point cloud scan.

8. The computerized method of claim 1, the method further comprising :
performing object recognition on the first point cloud and identifying objects in the first point cloud; and
identifying tag containers for one or more of the identified objects using the identification of the objects.

9. The computerized method of claim 1, the method further comprising:
determining a distance of the first object to a second object in the first point cloud; and
storing the distance of the first object to the second object in memory.

10. The computerized method of claim 1, the method further comprising :
receiving a search query comprising a request to identify objects within a specified distance of the first object in one or more point cloud scans;
identifying objects within the specified distance of the first object in one or more point cloud scans; and
providing search results comprising the identification of objects within the specified distance of the first object in one or more point cloud scans.

11. A computing system comprising:
a hardware computer processor;
a non-transitory computer readable medium having software instructions stored thereon, the software instructions executable by the hardware computer processor to cause the computing system to perform operations comprising:
accessing from memory a first point cloud scan;
providing a user interface displaying at least a portion of the first point cloud scan;
receiving selection from a user of a first object in the first point cloud scan displayed by the user interface;
receiving selection of a three-dimensional tag container;
placing the three-dimensional tag container at the selected first object in the first point cloud scan displayed by the user interface;
searching for an association of the selected first object with one or more data objects and identifying an association of the selected first object with at least a first data object; and
rendering a link graph graphically depicting the association of selected first object with the first data object.

12. The computing system of claim 11, wherein the tag container comprises a textual tag indicating an object type.

13. The computing system of claim 11, wherein the first data object comprises an entity, event, or document.

14. The computing system of claim 11, wherein the user interface comprises a resolution control configured to enable a user to change a resolution of the first point cloud scan in the user interface.

15. The computing system of claim 11, wherein the user interface and the first point cloud scan are rendered by a browser client of a user computing system, and wherein the user interface is configured to enable the user to rotate the point cloud scan rendered by the browser.

16. The computing system of claim 11, wherein the user interface and the first point cloud scan are rendered by an augmented reality or virtual reality headset.

17. The computing system of claim 11, the operations further comprising processing a two-dimensional image to generate the first point cloud scan.

18. The computing system of claim 11, the operations further comprising :
performing object recognition on the first point cloud and identifying objects in the first point cloud; and
identifying tag containers for one or more of the identified objects using the identification of the objects.

19. The computing system of claim 11, the operations further comprising:
determining a distance of the first object to a second object in the first point cloud; and
storing the distance of the first object to the second object in memory.

20. The computing system of claim 11, the operations further comprising :
receiving a search query comprising a request to identify objects within a specified distance of the first object in one or more point cloud scans;
identifying objects within the specified distance of the first object in one or more point cloud scans; and
providing search results comprising the identification of objects within the specified distance of the first object in one or more point cloud scans.
